(19) United States
(12) Patent Application Publication
(10) Pub. No.: US 2025/0259559 A1
(43) Pub. Date: Aug. 14, 2025

(54) ARCHITECTURE FOR AN EDUCATIONAL SYSTEM TO FACILITATE PROACTIVE ENGAGEMENT OF SPECIFIC STUDENT BEHAVIORS

(71) Applicant: RedCritter Corp., Flower Mound, TX (US)

(72) Inventors: Randy M. Whelan, Coppell, TX (US); Erika D. Lambert, Flower Mound, TX (US); Robert M. Beaty, Flower Mound, TX (US); James L. Rockett, JR., Carrollton, TX (US); Clyde H. Forland, III, Dallas, TX (US)

(21) Appl. No.: 18/438,778

(22) Filed: Feb. 12, 2024

(51) Int. Cl. G09B 5/00; G06Q 30/0207

(52) U.S. Cl. CPC G09B 5/00; G06Q 30/0207

(57) ABSTRACT

An architecture can be used within an educational system to facilitate proactive engagement of specific student behaviors. The architecture can include a pet collection module that leverages pet collections to create and manage pets within a virtual environment. The architecture allows teachers to cause their students' pets to solicit coins that represent desired student behaviors. When the students exhibit these desired student behaviors in the real world, the teachers may award the coins to the students' pets via the architecture. In this way, the students' desires to care for their pets in the virtual world can incentivize the students to perform well in the real world. The unique architecture allows such interactions to occur in a simple and easy-to-learn manner thereby enhancing the effectiveness of the educational system when used with younger students.

### CROSS-REFERENCE TO RELATED APPLICATIONS

N/A

### BACKGROUND

Schools and other educational/learning institutions struggle to maintain student engagement and promote successful learning outcomes. Many educational systems have been developed to attempt to encourage student engagement. Yet, such educational systems are oftentimes difficult to use and/or ineffective. Embodiments of the present disclosure are directed to a unique architecture for an educational system that improves upon existing educational systems by facilitating proactive engagement of specific student behaviors.

### BRIEF SUMMARY

An architecture can be used within an educational system to facilitate proactive engagement of specific student behaviors. The architecture can include a pet collection module that leverages pet collections to create and manage pets within a virtual environment. The architecture allows teachers to cause their students' pets to solicit coins that represent desired student behaviors. When the students exhibit these desired student behaviors in the real world, the teachers may award the coins to the students' pets via the architecture. In this way, the students' desires to care for their pets in the virtual world can incentivize the students to perform well in the real world. The unique architecture allows such interactions to occur in a simple and easy-to-learn manner thereby enhancing the effectiveness of the educational system when used with younger students.

In some embodiments, computer storage media can store computer executable instructions which when executed implement an architecture for an educational system to facilitate proactive engagement of specific student behaviors. The architecture can include a pet collection module configured to be deployed on an API server and to interface with client-side components that render a virtual environment. In response to a student purchasing a pet within the educational system, the pet collection module can create a pet object for the pet within a pet collection of the student, serialize the pet collection of the student, and store the serialized pet collection of the student in association with an account of the student within the educational system.

In some embodiments, a method may be implemented by an architecture that includes a pet collection module, and the method may facilitate proactive engagement of specific student behaviors within an educational system. A pet collection can be created for each of a plurality of students where each pet collection defines the respective student's pet in a virtual environment of the educational system and any coins desired by the respective student's pet. A pet collection of a first student may include a first pet object defining a first pet of the first student. A teacher may initiate a request to cause the first pet of the first student of the plurality of students to desire a first coin. In response to the request, the pet collection of the first student can be loaded. A coin object for the first coin can be created and added to the pet collection of the first student to thereby represent that the first pet of the first student desires the first coin. A representation of the first pet of the first student can be presented in the virtual environment with a representation of the first coin.

In some embodiments, an educational system is provided. The educational system may include one or more hardware components on which an API server is deployed. The API server may include a pet collection module, a reward store in which pets are available for purchase, and one or more application programming interfaces by which client-side components access the pet collection module and the reward store. The pet collection module may be configured to facilitate proactive engagement of specific student behaviors within the educational system by: receiving a notification that a first student has purchased a first pet from the reward store; creating a pet collection for the first student; creating a first pet object for the first pet; storing the first pet object in the pet collection for the first student; receiving a notification that a first teacher has sent a coin to the first pet; creating a first coin object for the coin sent to the first pet; storing the first coin object in the pet collection for the first student; receiving a notification that the first student has earned a coin; accessing the first coin object in the pet collection for the first student to determine that the earned coin matches the coin sent to the first pet; and incrementing an experience metric in the pet collection for the first student.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

These drawings depict only example embodiments and should not be considered limiting of the scope of the disclosed embodiments.

FIG. 1 illustrates an example computing environment in which one or more embodiments may be implemented.

FIG. 2 provides an example of various data structures that may be used in one or more embodiments of the present disclosure.

FIG. 3 provides an example of an architecture that is configured in accordance with one or more embodiments of the present disclosure and may therefore be used to enhance the functionality of an educational system.

FIG. 4 provides an example of how an admin can create a batch of digital coins that teachers may award to students.

FIGS. 5A-5D provide an example of how an architecture configured in accordance with one or more embodiments of the present disclosure can leverage pet collections when students purchase pets in an educational system.

FIGS. 6A-6C provide an example of how an architecture configured in accordance with one or more embodiments of the present disclosure can leverage pet collections to proactively engage specific student behaviors within an educational system.

### DETAILED DESCRIPTION

In this specification and the claims, the term “school” will be used to represent any educational or learning institute that may use an educational system that employs an architecture configured in accordance with one or more embodiments of the present disclosure. The term “student” will be used to represent an individual that may attend or otherwise participate in a school for educational or learning purposes. The term “teacher” will be used to represent an individual that teaches at a school. The term “admin” will be used to represent an individual that administrates an educational system for a school. Students, teachers, and admins may be considered users of the system. The term “coin” can represent any virtual object that can be awarded to students within the educational system. The term “pet” can represent any virtual representation of an animal or other living thing that a student may care for.

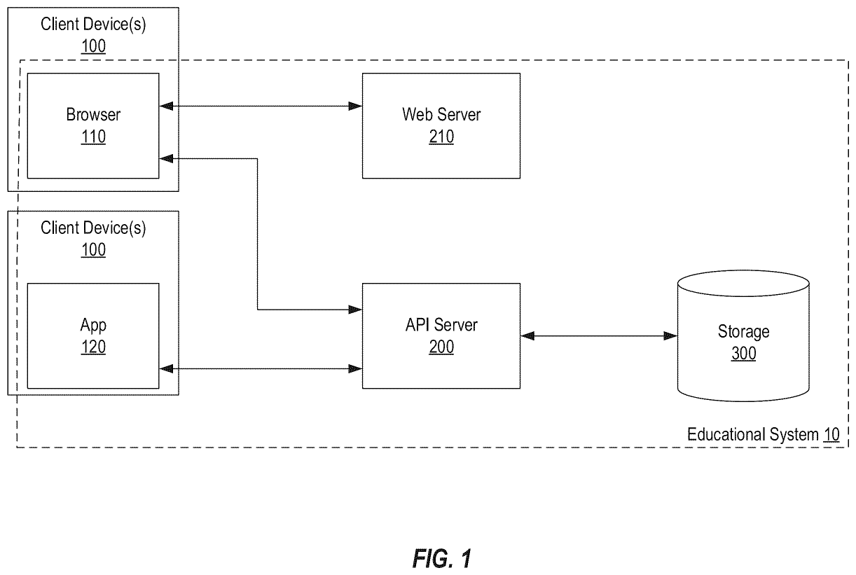

FIG. 1 provides an example of a computing environment in which embodiments of the present disclosure may be implemented. This environment includes an educational system 10 that may include an API server (or servers) 200, possibly a web server (or servers) 210, and storage 300. Users of client devices 100 may use a browser 110 to access web-based content provided by web server 210 and/or may use an app 120. In either case, the web-based content hosted in browser 110 or app 120 may interface with API server 200. Web-based content, app 120 or other software components on the client side will be referred to generally as client-side components. Of relevance to embodiments of the present disclosure, the client-side components are configured to generate a virtual environment where pets live and in which students may interact with the pets. The client-side components could present this virtual environment on any type of client device 100.

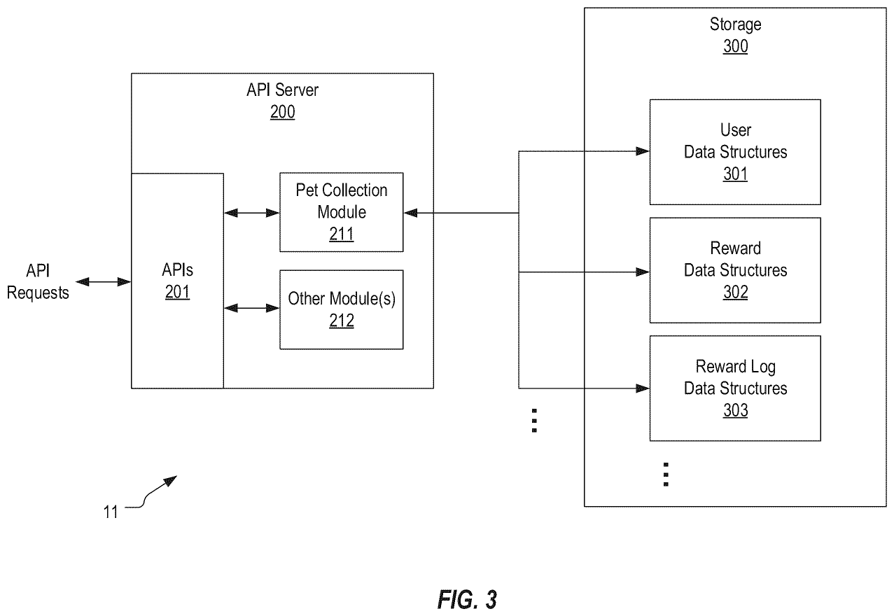

API server 200 can provide a number of APIs 201 (see FIG. 3) by which client devices 100 can interface with educational system 10 to implement functionality described herein. In this context, the term API should be construed broadly as encompassing an interface for receiving any type of communication for performing the functionality described herein. Likewise, the term API server should be construed as encompassing any service that is capable of performing the functionality described herein.

Storage 300 can represent any type or number of storage mechanisms for storing the data structures that educational system 10 may use to provide the functionality described below. For example, storage 300 may include relational databases, object storage, indexes, file systems, etc. Any or all of API server 200, web server 210, and storage 300 can be hosted in the cloud, implemented on dedicated hardware or provided in any other suitable manner.

Client device(s) 100 can represent any computing device that a user may use to interface with educational system 10. For example, a client device 100 may be a desktop, laptop, tablet, smart phone, virtual reality headset, television, etc. In typical implementations, there may be many schools that use educational system 10, and therefore, there may be many client devices 100 that users associated with such schools use to access educational system 10.

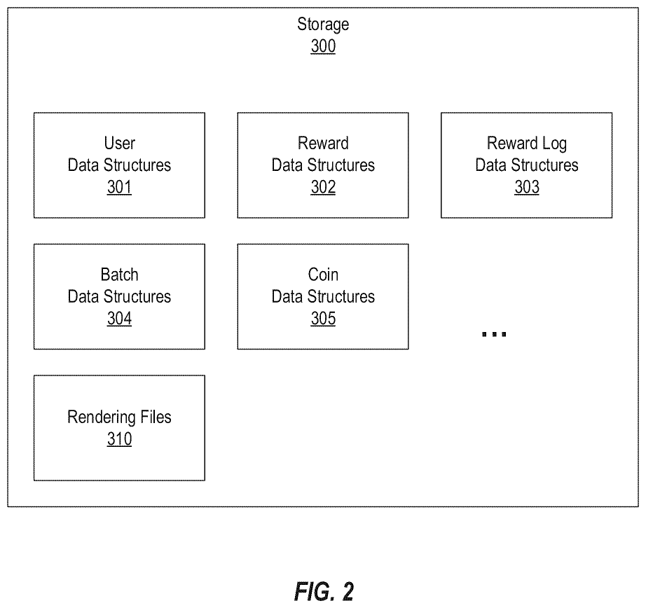

FIG. 2 provides an example of various data structures and files that educational system 10 may maintain in storage 300 for use in implementing one or more embodiments of the present disclosure. These data structures may include user data structures 301, reward data structures 302, Reward log data structures 303, batch data structures 304, coin data structures 305, and rendering files 310, among possibly many others. Embodiments of the present disclosure could be implemented in conjunction with the techniques described in U.S. patent application Ser. No. 17/703,444 (which relates to techniques for linking coins with NFTs within educational system 10) and U.S. patent application Ser. No. 18/450,992 (which relates to techniques for creating workflows that integrate AI and metaverse features into educational system 10), both of which are incorporated by reference. In embodiments where educational system 10 also implements such techniques, storage 300 may include additional data structures in accordance with the description of the incorporated applications.

As an overview, user data structures 301 may be used to define users, such as students, teachers, and admins, within a school. Reward data structures 302 may be used to define rewards that are available for students to purchase, such as pets, accessories, and food as described below. Reward log data structures 303 may be used to define instances of rewards that students have purchased. Batch data structures 304 may be used to define each batch of coins that schools have created within educational system 10. Coin data structures 305 may be used to define individual coins. Rendering files 310 can include 3D files and metadata that are used to render a 3D model of a reward or coin within the virtual environment presented to students.

FIG. 3 provides an example of an architecture 11 that can be employed within educational system 10 to facilitate proactive engagement of specific student behaviors. Architecture 11 may include a pet collection module 211 that is deployed as part of API server 200, possibly in conjunction with one or more other modules 212 (e.g., modules for implementing functionality described in the incorporated applications), as well as user data structures 301, reward data structures 302, and reward log data structures 303. In some embodiments, architecture 11 may also include some or all of the other components represented in FIGS. 1 and 2. However, the components of architecture 11 that are represented in FIG. 3 are primarily responsible for improving the functioning of educational system 10 for purposes of proactively engaging specific student behaviors. In other words, the unique configuration and functionality of architecture 11, which will be described in detail below, provide various technical improvements to educational systems such as educational system 10, and these technical improvements facilitate proactive engagement of specific student behaviors.

An overview of the technical improvements architecture 11 provides will now be given prior to describing the configuration and functionality of architecture 11 in detail. To facilitate proactive engagement of specific student behaviors in educational system 10, architecture 11 can enable students to obtain pets as rewards and can enable teachers to use these pets to encourage specific behaviors from their corresponding students. As introduced above, a pet can be a virtual representation of an animal or other character that requires attention from the student (e.g., to keep the pet alive, healthy, happy, etc.). The technical configuration of architecture 11 abstracts the students' and teachers' interactions with pets from the complex underlying communications and functionality that architecture 11 carries out to enable such interactions. Therefore, educational system 10 can be effectively used in elementary schools or other learning environments where the students may not be capable of learning and the teachers may not have time to learn complex systems.

More specifically, architecture 11 can provide pet collection module 211 that is deployed on API server 200 and that can be invoked via APIs 201 to instantiate pet collections by which pets are created and managed and through which teachers and students may interact with the pets. As represented in FIG. 3, pet collection module 211 can interface with user data structures 301, reward data structures 302 and reward log data structures 303 (among possibly other data structures) as part of its creation and management of and interactions with pets. Although not shown, in some embodiments, pet collection module 211 may also be configured to implement a pub/sub model for communicating back to students and teachers (or more specifically, for publishing communications to subscribed client-side components used by the teachers and students).

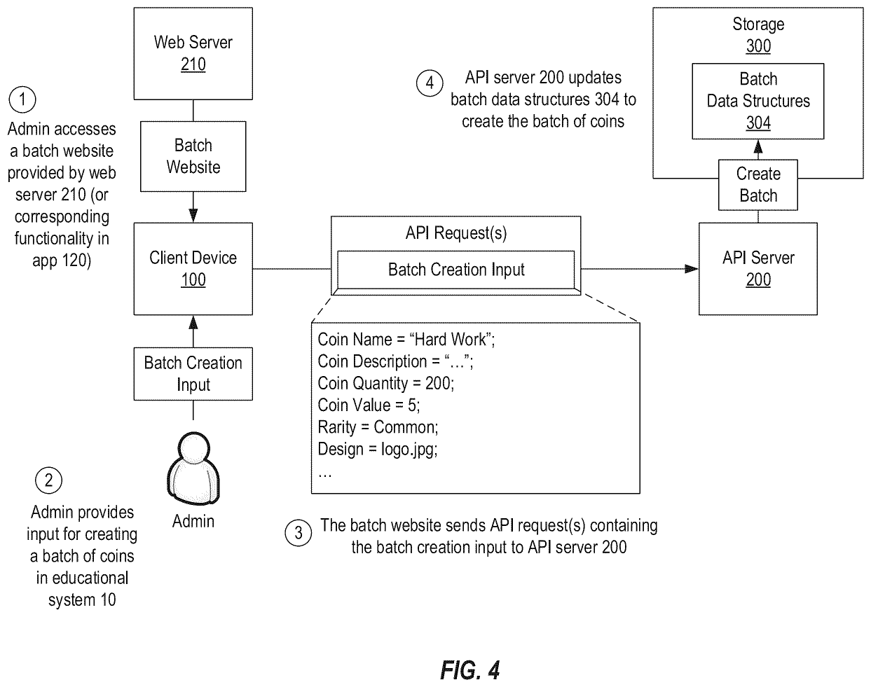

Pet collections may be configured to leverage coins as a triggering mechanism within architecture 11 for proactively engaging specific student behaviors within an educational system. The manner in which coins may be created in an educational system that leverages architecture 11 is not essential to embodiments of the present disclosure. However, because coins may be used as a primary triggering mechanism, FIG. 4 is provided as one example of how educational system 10 may allow an admin to create a batch of coins that teachers may then use to solicit specific student behaviors via pet collections.

In step 1, the admin may use a browser on client device 100 to access a batch website provided by web server 210. Alternatively, the admin may access corresponding functionality on app 120. In step 2, the admin may provide input for creating a batch of coins in educational system 10, and in step 3, the batch website (or app 120) can send one or more

API requests to API server 200 containing the batch creation input. As shown, this batch creation input may include a name of the coin (“Hard Work”), a coin description (e.g., “You're putting in a good effort in our class.”), a quantity of coins in the batch (200), a value of each coin in the batch (5), a rarity for the coins (common), a design for the coins (logo.jpg), etc. In step 4, API server 200 can use the batch creation input to update batch data structures 304 to thereby create/define the batch of coins. Although not shown, a batch of coins in batch data structures 304 could be given a unique ID (e.g., BatchID) and associated with a unique identifier of the school (e.g., SchoolID). Once a batch of coins is created within educational system 10, teachers at the school associated with the batch can be allowed to issue the coins to students including to use coins to proactively engage specific student behaviors via pet collections. Of primary importance to embodiments of the present disclosure, coins can be created to represent desired student behaviors. For example, in addition to the Hard Work coin in the example, an admin could create coins representing “Honesty,” “Kindness,” “Patience,” “Unity,” etc.

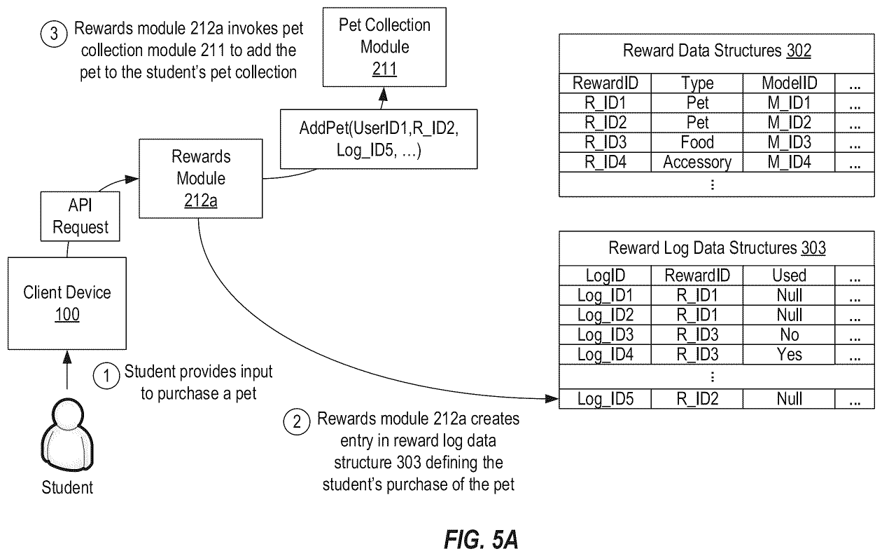

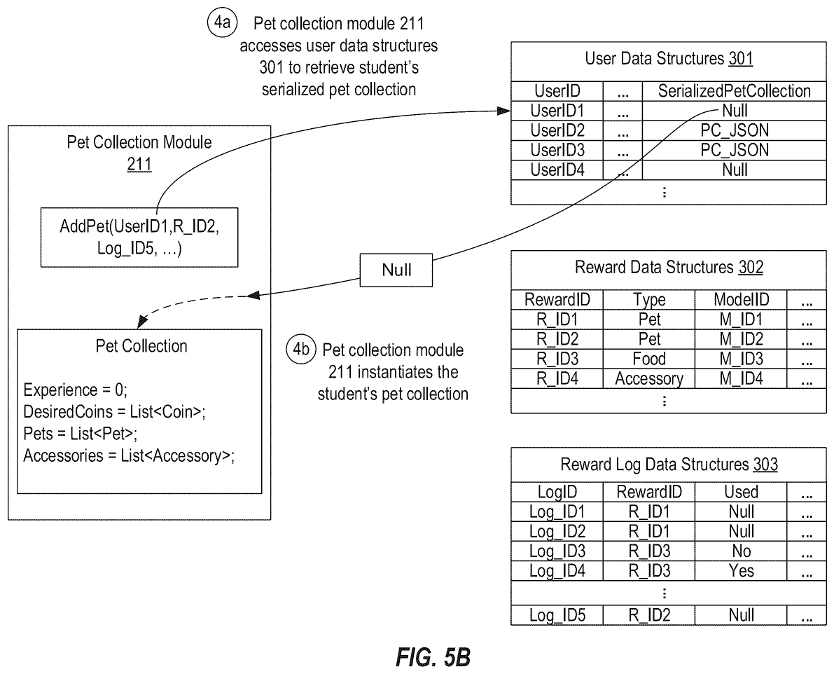

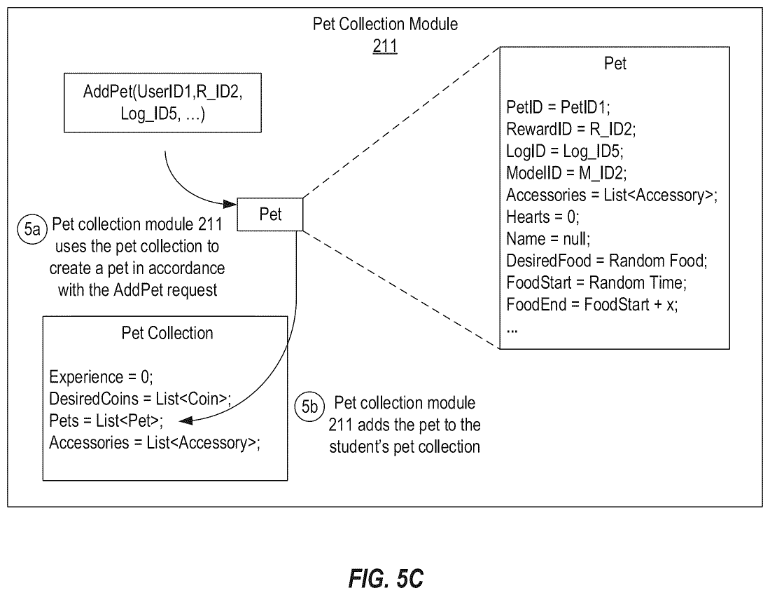

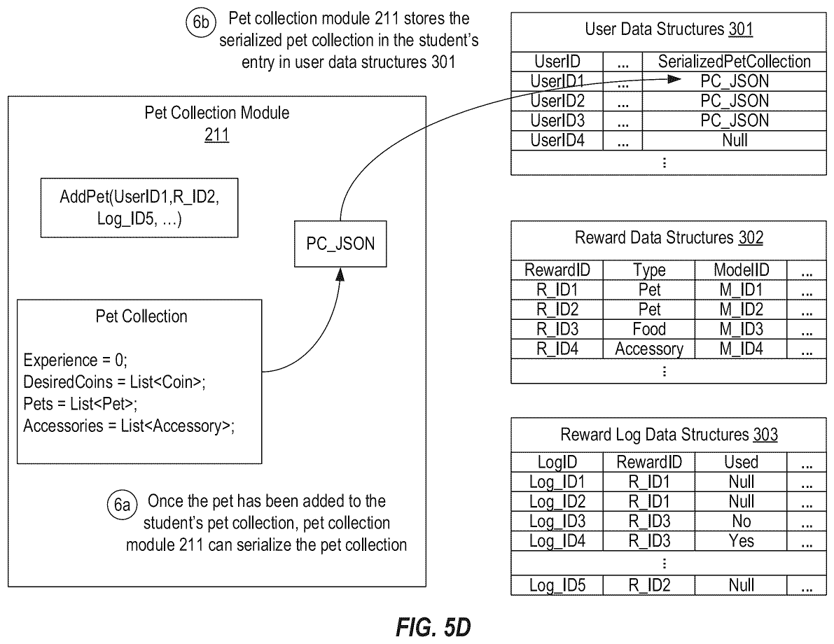

FIGS. 5A and 5B provide an example of how pet collection module 211 can enable a student to obtain (e.g., purchase) a pet. In technical terms, architecture 11 is configured so that, in response to a student's request for a pet, pet collection module 211 can leverage a pet collection to create the pet for the student. Pet collection module 211 is configured to perform this complex functionality in a manner that is transparent to the students.

For this example, it is assumed that reward data structures 302 include entries defining four different rewards: two pets, one food, and one accessory (e.g., a hat), all of which are associated with a unique reward identifier (R_ID1 through R_ID4 respectively). Each entry can also include a unique model identifier (M_ID1 through M_ID4 respectively) which identifies (e.g., via a pointer to an entry in rendering files 310) the 3D model and metadata for rendering the representation of the reward (e.g., 3D models of a bear, a dog, a head of lettuce, and a hat). In this example, it is assumed that a reward is one of a pet, a food, or an accessory, but other types of rewards could exist.

It is also assumed that reward log data structures 303 have been populated with entries defining rewards that students have already purchased (which in this example are two instances of the pet with a reward identifier of R_ID1 and two instances of the food with a reward identifier of R_ID3). Such entries include a log identifier (LogID) which uniquely identifies a single instance of a purchased reward, the reward identifier for the purchased reward, and possibly other information such as the type and ModelID. Also, in some embodiments, an entry in reward log data structures 303 could include a “Used” field which defines whether the reward has been used. For example, a food type reward could be configured to be used once (e.g., to be fed one time to a single pet), and therefore, the Used field could be set to No initially and then set to Yes after the student feeds the food to his or her pet.

Steps 1 and 2 represent functionality that can be performed when the student purchases a reward. For example, in step 1, the student, who is assumed to have a user identifier of UserID1, could access a rewards interface made available in browser 110 or app 120 to request the purchase of the pet having the rewards identifier of R_ID2 thereby causing a corresponding API request to be routed to API server 200 (e.g., to a rewards module 212a deployed on API server 200). In step 2, and assuming the student has sufficient funds for the purchase, rewards module 212a could create an entry in reward log data structures 303 for this purchased instance of the pet. This entry is assumed to have a log identifier of Log_ID5 and the reward identifier of R_ID2, among possibly other information. In step 3, which may be performed in conjunction with the successful purchase of the reward (e.g., in response to the entry being successfully added to reward log data structures 303), rewards module 212a can invoke pet collection module 211 to add the pet to the student's pet collection. For example, rewards module 212a could invoke an AddPet function and pass the student's user identifier, the reward identifier for the purchased reward, and the log identifier for the instance of the purchased reward, among possibly other information such as the type, ModelID, etc.

Turning to FIG. 5B, it is further assumed that user data structures 301 include entries having a UserID field for storing an identifier of the student and a SerializedPetCollection field for storing a serialized version of a pet collection for the student, among possibly many other fields. In some embodiments, a serialized version of a pet collection may be in the form of a JSON object. In the depicted example, it is assumed that a pet collection has not yet been created for the students having user identifiers of UserID1 and UserID4 and therefore the SerializedPetCollection field is null for these entries. In contrast, the entries for the students having user identifiers of UserId2 and UserID3 each include a serialized version of a pet collection (PC_JSON) indicating that a pet collection has been created for these students.

Turning to FIG. 5B, in step 4a, pet collection module 211 can respond to the request to add the pet by accessing user data structures 301 to retrieve the student's pet collection, and then in step 4b, can instantiate the pet collection. In some embodiments, a pet collection can define each of the student's pets (e.g., as a list of Pet objects), each of the student's accessories (e.g., as a list of Accessory objects), each coin that the student's pet(s) desire (e.g., as a list of Coin objects), and an experience metric. In this example, because the student's entry does not include a serialized pet collection, step 4b can entail instantiating a default pet collection (e.g., a pet collection where the Desired Coins, Pets, and Accessories lists are empty, and the Experience metric is zero). In contrast, if the student's entry includes a serialized pet collection, step 4b can entail deserializing the serialized pet collection into the instantiated pet collection (e.g., by populating the Desired Coins, Pets, and Accessories lists and the Experience metric with the corresponding values in the serialized pet collection).

Turning to FIG. 5C, in step 5a, pet collection module 211 can use the instantiated pet collection to create the pet for the student in accordance with the request received in step 3. In some embodiments, a pet can be defined using a unique pet identifier (PetId1), the reward ID, log ID and model ID, a list of Accessory objects (which can be used to define which of the student's purchased accessories the student has assigned to the particular pet), a hearts metric (which can be used within educational system 10 to represent a status/health of the pet), a name for the pet, and a desired food and food start and end times (which can be used within educational system 10 to define the type of food the pet desires and when the student should feed the pet this food to obtain experience), among possibly other information. In step 5b, pet collection module 211 can add the pet to the student's pet collection such as by adding the pet object to the Pets list.

Turning to FIG. 5D, in step 6a, pet collection module 211 can serialize the student's pet collection, which now includes the created pet, and in step 6b, can store the serialized pet collection in the student's entry in user data structures 301. At this point, pet collection module 211 can complete the AddPet request which in some embodiments could include publishing a notification that the pet has been created which targets the client-side components the student uses to access educational system 10. In some embodiments, the client-side components could respond to this notification by invoking pet collection module 211 to identify the pet and to retrieve the files necessary to render the pet in the virtual environment.

Pet collection module 211 could be configured to follow a similar process to delete a pet from a student's pet collection. For example, in some embodiments, educational system 10 may allow a student to sell or otherwise transfer a pet to another student. In such cases, pet collection module 211 can instantiate a pet collection to deserialize the student's pet collection and then use the pet collection to delete the pet object from the Pets list.

Similar functionality may also be performed when the student purchases additional pets and accessories (e.g., by creating and adding an accessory object to the Accessories list in the student's pet collection). Pet collection module 211 can also expose functions accessible via APIs 201 to allow the student to name the pet and may use the student's pet collection to update the pet's name. In short, pet collection module 211 and pet collections provide an abstracted interface by which the client-side components can invoke functionality in response to students' and teachers' interactions with pets in a virtual environment.

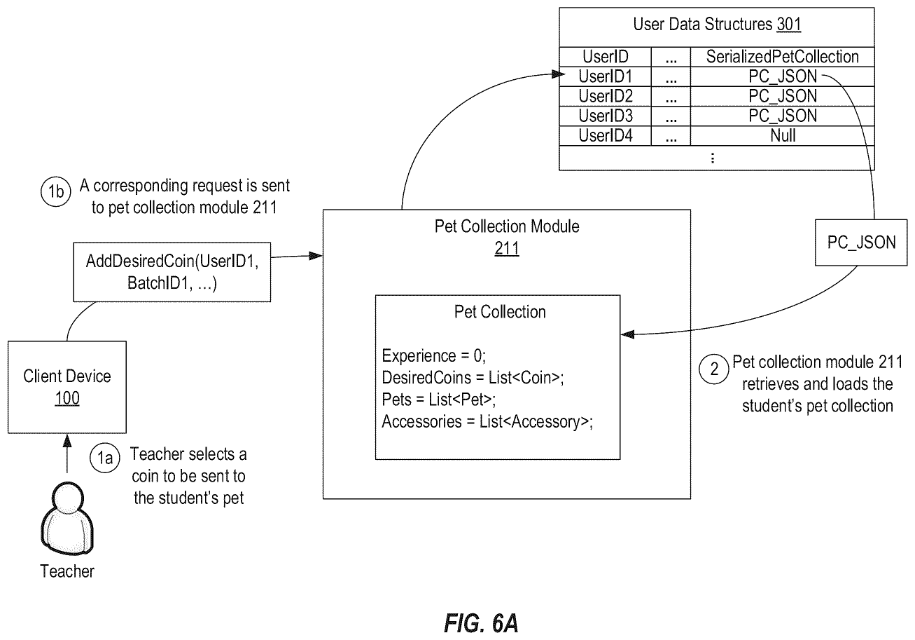

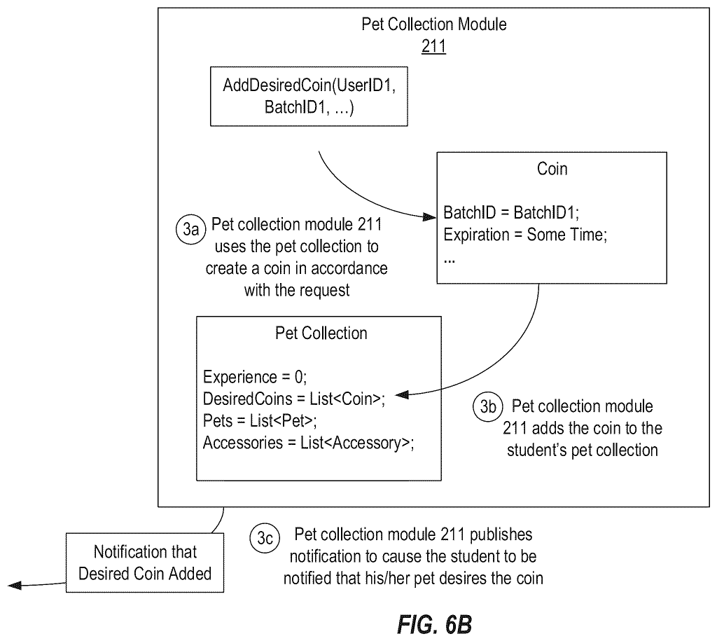

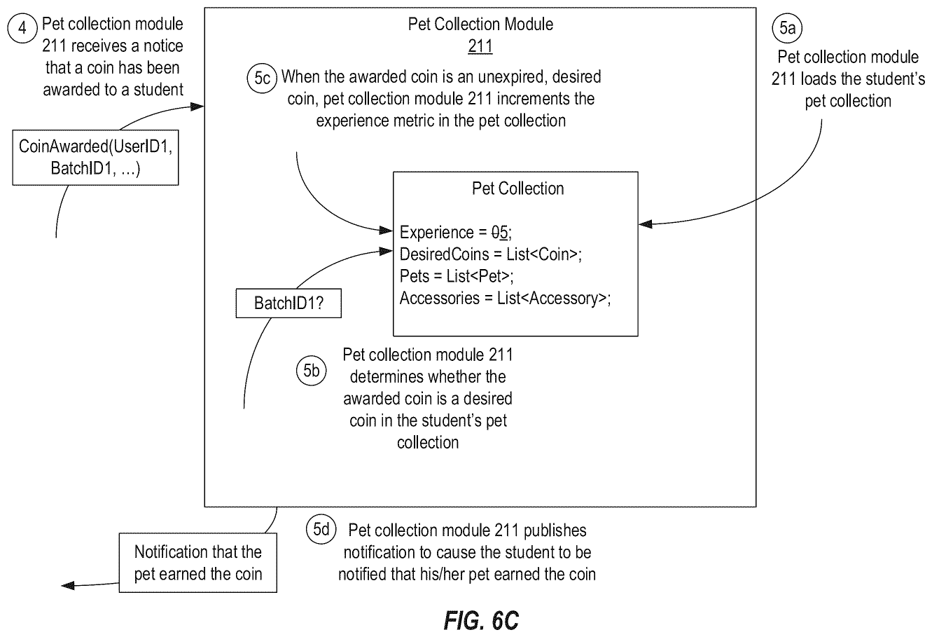

FIGS. 6A-6C provide an example of how pet collection module 211 can facilitate the proactive engagement of specific student behaviors within educational system 10. In particular, these figures show how a teacher can use coins and pets within the virtual environment of educational system 10 to incentivize students to exhibit, in the real world, the behaviors the coins represent.

Turning to FIG. 6A, in step 1a, it is assumed that a teacher uses client device 100 to select a coin to be sent to a particular student's pet. For example, educational system 10 could provide an interface in which teachers can select from among the available coins and can select one or more students to whose pet(s) the coin(s) should be sent. In step 1b, a corresponding request can be sent by the client-side components to pet collection module 211 via APIs 201. For example, an AddDesiredCoin request could be invoked and could specify the student's identifier (UserID1) and the coin's identifier (BatchID1). In step 2, pet collection module 211 can respond to this request by instantiating a pet collection, retrieving the student's serialized pet collection and loading it into the instantiated pet collection. For purposes of this example, it will be assumed that the student's pet collection is in the state represented in FIG. 5D (i.e., a single pet is defined in the pet collection and no coins or accessories are defined).

Turning to FIG. 6B, in step 3a, pet collection module 211 can use the pet collection to create a coin in accordance with the request. For example, pet collection module 211 could create a coin object that defines a coin identifier of BatchID1 and defines an expiration time for the coin. The expiration could define how long the student has to earn the coin. In step 3b, pet collection module 211 can add the coin to the student's pet collection such as by adding the coin object to the DesiredCoins list. After adding the desired coin to the pet collection, pet collection module 211 could deserialize the pet collection back to the student's entry in user data structures 301 and, in step 3c, could publish a notification that the student's pet desires the coin. The client-side components could respond to such a notification by causing a virtual representation of the pet to indicate that it desires the particular coin. In this way, the student can know that he or she needs to exhibit the behavior associated with the coin in order to satisfy the pet's desire.

In some embodiments, pet collection module 211 could perform additional functionality as part of its processing of a request to add a desired coin to a pet collection. For example, upon loading the student's pet collection, pet collection module 211 could evaluate the pet collection to determine whether the targeted student has any pets, and if not, could fail the request. As another example, pet collection module 211 could determine whether the coin has already been added to the student's pet collection, and if so, could extend the expiration time of the existing coin.

To exemplify how architecture 11 and its functionality facilitate proactive engagement of specific student behaviors, it can be assumed that coins having the identifier of BatchID1 are the “Hard Work” coins depicted in FIG. 4. Accordingly, by sending the Hard Work coin to the student's pet, the teacher can incentivize the student to exhibit hard work so that the teacher can award the Hard Work coin to the student. Pet collection module 211 and the pet collections it utilizes provides a simplified and abstracted way for this type of encouragement to occur in the context of an educational system.

FIG. 6C represents functionality that pet collection module 211 can perform when a student is awarded a coin. The manner in which coins are awarded in educational system 10 is not essential to embodiments of the present disclosure. Regardless of how the coin is awarded, in step 4, pet collection module 211 can receive a notice that the coin has been awarded. This notice could identify the student (UserID1) and the coin (BatchID1). In step 5a, pet collection module 211 could load the student's serialized pet collection in a similar manner as described above. In step 5b, pet collection module 211 can determine whether the awarded coin is a desired coin within the student's pet collection. For example, pet collection module 211 could compare the coin identifier included in the notice of step 4 with the coin identifier of each coin in the DesiredCoins list. In some embodiments, pet collection module 211 could be configured to remove any expired coins as part of step 5b.

In step 5c, and assuming the awarded coin is a desired coin that is not expired, pet collection module 211 can increment the experience metric in the pet collection. In some embodiments, the increment could be predefined, defined in the notice, or defined in the coin itself (e.g., the coin value of 5 shown in FIG. 4). In conjunction with incrementing the experience metric, pet collection module 211 could also remove the matching coin from the DesiredCoins list. If the processing of the notice results in changes to the pet collection, pet collection module 211 could serialize the pet collection back to user data structures 301. Also, if the pet has earned the coin, in step 5d, pet collection module 211 can publish a corresponding notification which can in turn cause the client-side components to present a representation (e.g., an animation) of the pet receiving the coin to thereby inform the student.

In some embodiments, a pet collection's experience metric can be used to incentivize students to interact with their pets. For example, the value of each student's experience metric could be used when the student's pets are involved in games, competitions, or other activities within a virtual environment in educational system 10 (e.g., to unlock levels, to obtain virtual skills or items, etc.). In some embodiments, the experience metric could apply generally to the pet collection (i.e., to all pets in the pet collection) or a different experience metric could apply to each pet in the pet collection.

In some embodiments, pet collection module 211 may further incentivize desired behaviors by causing the pets to solicit food from their students. The process for notifying students that their pets desire food can be generally similar to the process for notifying students that their pets desire coins. For example, each time a student uses client-side components to access the virtual world in which his or her pet(s) live, pet collection module 211 can load the student's pet collection and process each pet defined therein. With reference to FIG. 5C, pet collection module 211 could access the DesiredFood parameter of each pet in the pet collection to determine which food each pet desires and could then publish a notification to cause the client-side components to present a representation indicative of the pet's desire for the food.

When the student uses the client-side components to interact with the pet and sees that the pet desires a particular food, the student can use the client-side components to purchase the food in a similar manner as the student purchases a pet as is represented in FIGS. 5A-5C. For example, a request to feed a pet can be sent to pet collection module 211 and can identify the student, the pet, and the food that the pet is to be fed, among possibly other information (e.g., similar to step 3 in FIG. 5A). In response, pet collection module 211 can load the student's pet collection, access the pet object in the pet collection for the pet that is to be fed, and then update the pet object accordingly. For example, with reference to FIG. 5C, pet collection module 211 could increment the hearts metric. In some embodiments, the hearts metric could be incremented based on the purchase price of the food. In some embodiments, the increment to the hearts metric could be enhanced if the food is the desired food. In other words, the student may be allowed to feed his or her pet any type of food at any time but may receive a greater increment to the hearts metric by feeding the desired food within the window defined with the FoodStart and FoodEnd parameters. In some embodiments, pet collection module 211 may also be configured to update entries in reward log data structures 303 to define when food has been used to thereby allow a student to feed a purchased food only once. In some embodiments, after the student feeds his or her pet a desired food or after the current desired food has expired, pet collection module 211 can choose another desired food, update the pet object accordingly, and publish a corresponding notification to cause the client-side components to inform the student of the new desired food.

A student may earn the currency to purchase a pet, any accessories, and the food to feed the pet by performing well within educational system 10 and/or in the real world. For example, educational system 10 could be configured to issue currency in conjunction with the award of a coin, when students complete tasks in a virtual world or other environment within educational system 10, when requested by a teacher or administrator, or some other manner. The incentive to have a pet and to feed the pet to keep the pet healthy can further encourage the students to exhibit desired behaviors to thereby earn sufficient currency. Architecture 11 (or other architecture configured in accordance with embodiments of the present disclosure), and particularly pet collection module 211 and its pet collections, enable these interactions without the learning curve and pitfalls that are prevalent in many educational systems. For example, from the students' perspective, they simply need to exhibit desired behaviors to be able to care for their virtual pets, and from the teachers' perspective, they simply need to send coins to the pets to solicit the desired behaviors. Meanwhile, pet collection module 211 abstracts the complexities of the underlying pet collections and other architectural components that make the simple interactions possible.

Architecture 11 can also facilitate the addition of other features to an educational system for enriching the educational experience. For example, as suggested above, pets (or at least their experience level) can be used as part of games or other activities where having a higher experience level is desired. The students' desires to participate in such games and activities can further incentivize their participation in the educational system so as to have the highest experience level possible.

In summary, embodiments of the present disclosure are directed to a unique architecture which allows educational systems to seamlessly integrate complex functionality for the proactive engagement of specific student behaviors while maintaining a simple and easy-to-use interface for students and teachers to access such functionality. Therefore, educational systems that leverage an architecture configured in accordance with embodiments of the present disclosure are more likely to be successful in engaging students and enhancing the educational process.

Embodiments of the present disclosure may comprise or utilize special purpose or general-purpose computers including computer hardware, such as, for example, one or more processors and system memory. Embodiments within the scope of the present disclosure also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present disclosure can be hosted in a cloud environment.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. One or more computer storage media storing computer executable instructions which when executed implement an architecture for an educational system to facilitate proactive engagement of specific student behaviors, the architecture comprising:
a pet collection module configured to be deployed on an API server and to interface with client-side components that render a virtual environment;
wherein, in response to a student purchasing a pet within the educational system, the pet collection module is configured to create a pet object for the pet within a pet collection of the student, serialize the pet collection of the student, and store the serialized pet collection of the student in association with an account of the student within the educational system.

2. The computer storage media of claim 1, wherein the architecture includes one or more user data structures, and wherein storing the serialized pet collection of the student in association with the account of the student within the educational system comprises storing the serialized pet collection of the student in an entry for the student in the one or more user data structures.

3. The computer storage media of claim 1, wherein, in response to the student purchasing the pet within the educational system, the pet collection module receives a request to create the pet that includes an identifier of the student and an identifier of the pet.

4. The computer storage media of claim 1, wherein creating the pet object for the pet within the pet collection of the student comprises one of:
instantiating a pet collection, deserializing the serialized pet collection of the student into the instantiated pet collection, and adding the pet object for the pet to the instantiated pet collection; or
instantiating a default pet collection and adding the pet object for the pet to the instantiated pet collection.

5. The computer storage media of claim 1, wherein creating the pet object for the pet within the pet collection comprises adding the pet object to a list of pet objects in the pet collection.

6. The computer storage media of claim 1, wherein the pet collection module is further configured to:
receive a request, initiated by a teacher, to add a desired coin to the pet collection of the student;
in response to the request to add the desired coin, loading the serialized pet collection of the student;
creating a coin object for the desired coin and adding the coin object to the pet collection of the student;
after the coin object has been added to the pet collection of the student, serialize the pet collection and store the serialized pet collection in association with the account of the student within the educational system; and
cause the client-side components to render, in the virtual environment, a representation of the pet in which the pet desires the desired coin to thereby incentivize the student to earn the desired coin within the educational system.

7. The computer storage media of claim 6, wherein the desired coin is associated with a desired student behavior.

8. The computer storage media of claim 6, wherein the pet collection module is further configured to:
in response to receiving a notification that the student has earned a coin within the educational system, loading the serialized pet collection of the student;
accessing the coin object in the pet collection of the student to determine that the earned coin matches the desired coin;
in response to determining that the earned coin matches the desired coin, updating an experience metric in the pet collection of the student; and
after updating the experience metric in the pet collection of the student, serialize the pet collection and store the serialized pet collection in association with the account of the student within the educational system.

9. The computer storage media of claim 1, wherein, in response to the student purchasing an accessory within the educational system, the pet collection module is configured to:
load the serialized pet collection of the student;
create an accessory object for the accessory within the pet collection of the student;
update the pet object for the pet within the pet collection of the student to associate the accessory with the pet;
after creating the accessory object for the accessory within the pet collection and updating the pet object for the pet to associate the accessory with the pet, serialize the pet collection of the student; and
store the serialized pet collection of the student in association with an account of the student within the educational system.

10. The computer storage media of claim 1, wherein the pet collection module is further configured to:
receive a request, initiated by the student, to feed a type of food to the pet;
in response to the request to feed the type of food to the pet, loading the serialized pet collection of the student;
accessing the pet object within the pet collection of the student to determine a desired food of the pet;
in response to determining that the type of food matches the desired food, incrementing a hearts metric defined in the pet object for the pet;
after incrementing the hearts metric, serialize the pet collection of the student; and
store the serialized pet collection of the student in association with an account of the student within the educational system.

11. The computer storage media of claim 10, wherein the pet collection module is further configured to:
in conjunction with determining that the type of food matches the desired food, select new desired food for the pet and adding the new desired food to the pet object; and
cause the client-side components to render, in the virtual environment, a representation of the pet in which the pet desires the new desired food.

12. A method, implemented by an architecture that includes a pet collection module, for facilitating proactive engagement of specific student behaviors within an educational system, the method comprising:
creating, for each of a plurality of students, a pet collection that defines the respective student's pet in a virtual environment of the educational system and any coins desired by the respective student's pet, including a pet collection of a first student that includes a first pet object defining a first pet of the first student;
receiving a request, initiated by a teacher, to cause the first pet of the first student of the plurality of students to desire a first coin;
in response to the request, loading the pet collection of the first student;
creating a coin object for the first coin and adding the coin object to the pet collection of the first student to thereby represent that the first pet of the first student desires the first coin; and
causing a representation of the first pet of the first student to be presented in the virtual environment with a representation of the first coin.

13. The method of claim 12, further comprising:
receiving a notification that a coin has been awarded to the first student within the educational system;
in response to the request, loading the pet collection of the first student;
accessing the coin object for the first coin in the pet collection of the first student to determine that the coin that has been awarded to the first student matches the first coin to thereby determine that the student has earned the first coin that is desired by the first pet of the first student; and
incrementing an experience metric of the pet collection of the first student.

14. The method of claim 13, wherein the first coin is associated with a desired student behavior.

15. The method of claim 12, further comprising:
receiving a request, initiated by the first student, to feed the first pet a first type of food;
in response to the request to feed the first pet the first type of food, loading the pet collection of the first student;
accessing the first pet object in the pet collection of the first student to identify a desired food of the first pet; and
in response to determining that the desired food matches the first type of food, incrementing a hearts metric defined in the pet collection of the first student by a first amount.

16. The method of claim 15, wherein the first amount is based on a value of the first type of food.

17. The method of claim 16, wherein the first amount is a multiple of the value of the first type of food because the desired food matches the first type of food.

18. The method of claim 12, further comprising:
storing serialized versions of the pet collections in conjunction with identifiers of the respective students.

19. The method of claim 12, wherein each of the pet collections is created in response to the respective student's request to purchase a pet in the educational system.

20. An educational system comprising:
one or more hardware components on which an API server is deployed, the API server including a pet collection module, a reward store in which pets are available for purchase, and one or more application programming interfaces by which client-side components access the pet collection module and the reward store;
wherein the pet collection module is configured to facilitate proactive engagement of specific student behaviors within the educational system by performing the following:
receiving a notification that a first student has purchased a first pet from the reward store;
creating a pet collection for the first student;
creating a first pet object for the first pet;
storing the first pet object in the pet collection for the first student;
receiving a notification that a first teacher has sent a coin to the first pet;
creating a first coin object for the coin sent to the first pet;
storing the first coin object in the pet collection for the first student;
receiving a notification that the first student has earned a coin;
accessing the first coin object in the pet collection for the first student to determine that the earned coin matches the coin sent to the first pet; and
incrementing an experience metric in the pet collection for the first student.
